(19) United States
(12) Patent Application Publication
(10) Pub. No.: US 2004/0156009 A1
(43) Pub. Date: Aug. 12, 2004

(54) Joint structure of eyeglass frame and temple

(76) Inventor: Hsien-Jung Yeh, Tainan City (TW)

Correspondence Address: Alan D. Kamrath, Rider, Bennett, Egan & Arundel, LLP, 333 South Seventh Street, Suite 2000, Minneapolis, MN, 55402, US

(21) Appl. No.: 10/360,173

(22) Filed: Feb. 7, 2003

(51) Int. Cl. G02C 1/00

(52) U.S. Cl. 351/41

(57) ABSTRACT

The invention relates to a joint structure of an eyeglass frame and temples. A joint base on the inside end of the temple is joined to a horizontal dividing face, and a joint on the horizontal dividing face then is engaged with an upper and lower joint holder on either end of the frame, then a screw fixture is used to complete the movement assembling, and thus preventing both temple ends from touching a lens when the temples are folded inward.

### BACKGROUND OF THE INVENTION

1. Field of the Invention

The invention relates to a joint structure of an eyeglass frame and temples, particularly to prevent the temples from touching a lens when the temples on either end of the frame are not in use and have been folded inward.

2. Description of the Related Art

To ensure eyeglasses remain as new after longtime use, the eyeglass industry has attempted to develop and design all components of eyeglasses to be able to prevent the deformation and scratching caused by external force and negligence, as well as using simple and easy assembling techniques to accomplish the fastening and assembling the components.

### SUMMARY OF THE INVENTION

This invention uses the same eyeglass formation described above, to create a newly structured style of an eye glass frame and temples, so that when the user folds the eyeglasses, the ends of the temples avoid touching the inner side of the lenses due to the restriction on the temples' position.

It's one object of the present invention to provide a joint base protruding from the inner end of the temple and forming a horizontal dividing face, which is the connecting part of a joint and an upper and lower joint holder of the eyeglass frame, then finishing the movement assembly by using a screw fixture. Thus when a user folds the left and right temples inward, the ends of the temples won't touch the lens due to the restriction of the temples position.

It's another object of the present invention to provide a thin connection between inner walls of both ends of the frame and the upper and lower joint holder, which can be inserted into indentations on both ends of the temples tightly, thus when mounting the lens and the frame they can be kept in a good and firm union.

The above and other objects, features and advantages of the present invention will become apparent from the following detailed description taken with the accompanying drawings.

### BRIEF DESCRIPTION OF THE DRAWING

FIG. 1 is an exploded perspective view of a joint structure of an eyeglass frame and temples according to the invention;

FIG. 2 is a sectional exploded view of FIG. 1;

FIG. 3 is a perspective view of FIG. 1;

FIG. 4 is a view illustrating the folding movement of the eyeglass temple;

FIG. 5 is a sectional detailed view of FIG. 4.

### DETAILED DESCRIPTION OF THE PREFERRED EMBODIMENT

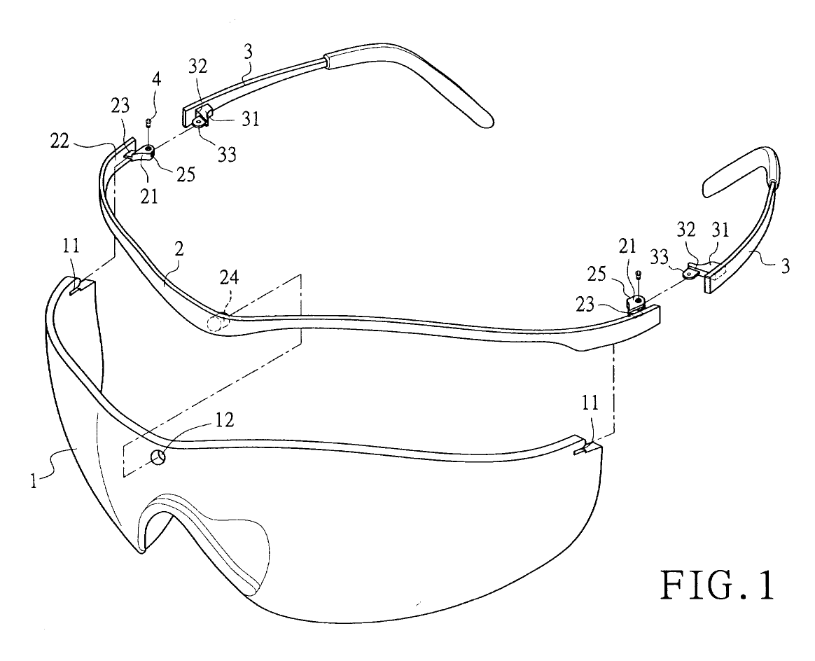

Referring to FIG. 1, there is shown a joint structure of an eyeglass frame and temples in accordance with the invention. The structure comprises a lens 1, a frame 2 and a left and right temple 3. The lens 1 includes indentations 11 on both ends, and there is a small hole 12 between the indentations 11. The frame 2 include s upper and lower joint holders 21 extend from inner walls 22 of both ends, and there is a thin connection 23 between the inner wall 22 and the upper and lower joint holder 21. In the center of the frame 2 is a protruding piece 24, which protrudes inwards. The inside end of the temple 3 protrudes a joint base 31, a horizontal dividing face 32 is formed forward, from which juts out a joint 33.

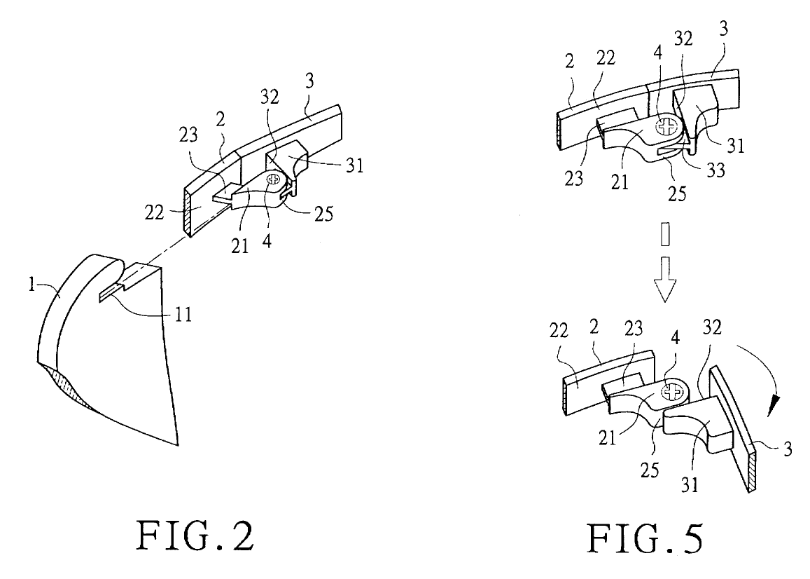

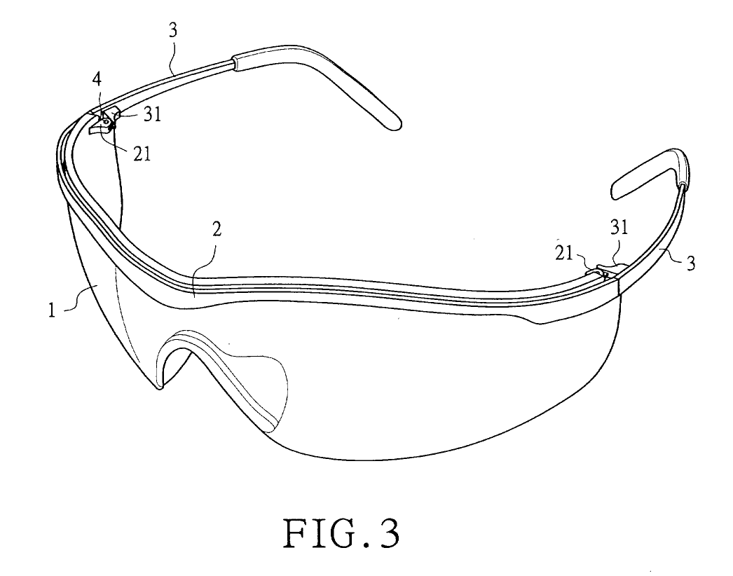

Referring to FIG. 2, the joint 33 on the joint base 31 of the temple 3 is put into the upper and lower joint holder 21 on the frame 2 and combined by a screw fixture 4 to assemble these two parts into a movable and rotatable structure; thereupon piercing the protruding piece 24, in the middle of the frame 2, into the hole 12 on the lens 1. Then put the thin connections 23, between the end of the frame 2 and the upper and lower joint holder 21, into the indentation 11 on the lens 1. Therefore, the lens 1 and the frame 2 can keep in a pressing stable status after assembling as shown in FIG. 3.

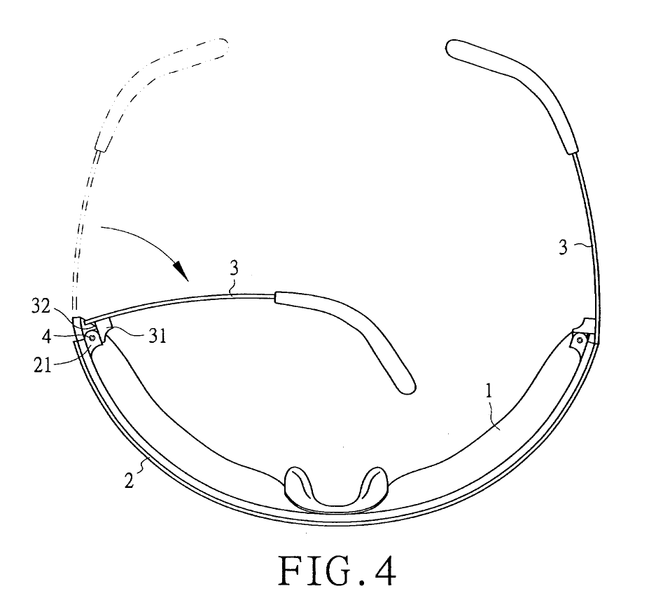

To fold the temples (refer to FIGS. 4 and 5) when a user is not wearing the eyeglasses, first fold the left and right temple 3 inward by hand. When both temples have been folded, the horizontal dividing face 32 on the front side of the joint base 31 will be completely against the edge 25 of the upper and lower joint holder 21 on the frame 2 as shown in FIG. 5, thus will reach the maximum confine of the temple 3 folding (refer to the left temple folded inward illustrated in FIG. 4), so as to prevent the ends of both temples 3 touching the inner side of the lens 1 when folded inward and protect the lens 1 from getting scratches due to the temples 3 being excessively folded inwards.

While the preferred embodiment of the invention has been described above, it will be recognized and understood that various modifications may be made therein, and the appended claims are intended to cover all the modifications, which may fall within the spirit and scope of the invention.

What is claimed is:

1. A joint structure of an eyeglass frame and temples comprising:
an upper and lower joint holders extending from an inner wall of either end of the frame;
a joint base on the inner side of either end of the temple forming forward a horizontal dividing face;
a joint jutting out of said horizontal dividing face and engaged to said upper and lower joint holder; and
a screw fixture completing the movement assembling so as to prevent the ends of the temples to touch a lens when the temples are folded inward.

2. The joint structure of claim 1, wherein said upper and lower joint holder and said inner wall of the frame is connected by a thin connection which can be tightly inserted into an indentation on either end of the lens, and keep the assembly of the frame and the temples firm.
